(19) United States
(12) Patent Application Publication
(10) Pub. No.: US 2008/0133349 A1
(43) Pub. Date: Jun. 5, 2008

(54) Online Abandonment Recovery

(76) Inventors: Ali Nazer, San Francisco, CA (US); Isao Yagi, San Francisco, CA (US); Nischal Muthanna Ammatanda, Fremont, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/871,917

(22) Filed: Oct. 12, 2007

Related U.S. Application Data
(60) Provisional application No. 60/829,272, filed on Oct. 12, 2006.

(51) Int. Cl. G06Q 30/00

(52) U.S. Cl. 705/14; 705/26; 705/27

(57) ABSTRACT

A seller of online merchandise reduces the number of incomplete transactions by offering incentives to consumers to complete transactions. When a consumer adds an item to an online shopping cart, a monitoring page is opened in the consumer's browser. If the consumer abandons the shopping cart, for example by closing the browser window or navigating away from the seller's web site, the monitoring window is maximized and redirected to an offer page. The offer page presents the consumer with an incentive to purchase the items abandoned in the shopping cart. If the consumer accepts the incentive, he is redirected to a page where the order is completed. Incentives may be offered in some embodiments to customers who view an item and leave the site, even if the item was not actually placed in a shopping cart.

### CROSS-REFERENCE TO RELATED APPLICATIONS

This application claims the benefit of U.S. Provisional Application Ser. No. 60/829,272, filed Oct. 12, 2006 and incorporated by reference herein in its entirety.

### BACKGROUND OF THE INVENTION

1. Field of the Invention

The present invention relates generally to online shopping. In particular, the present invention is directed to providing customers with incentives to complete online shopping transactions.

2. Description of Background Art

Many transactions are completed using the Internet, including the purchase of goods and services. Typically, a consumer visits a web site and searches for items of interest. When the consumer discovers an item that he wishes to purchase, he adds it to what is commonly known as a shopping cart. The shopping cart contains the set of items the consumer has indicated he would like to purchase during that session. When the consumer has finished searching for items and wishes to complete the transaction, typically he will be asked to review the items in his shopping cart and, once satisfied with the contents, to authorize payment for the transaction. At that point the shopping cart is emptied and the order is queued for fulfillment.

Often, however, the online transaction is not completed and the sale is lost. This can happen for a number of reasons, for example if the consumer loses interest, is distracted, finds an alternative supplier, or never intended to complete the transaction. This kind of uncompleted transaction is known as shopping cart abandonment. Some industry research reports have estimated that online retail sites lose as much as 67% of potential sales because of consumers abandoning their shopping carts without completing the purchase process they initiated.

### SUMMARY

The present invention enables a seller of online merchandise or services to reduce the number of incomplete transactions by offering incentives to consumers to complete transactions they would otherwise abandon. When a consumer adds an item to an online shopping cart, a monitoring page is opened in the consumer's browser. Upon an indication that the consumer has abandoned the shopping cart, for example by closing the browser window or navigating away from the seller's web site, the monitoring window is maximized and redirected to an offer page. The offer page presents the consumer with an incentive to purchase the items abandoned in the shopping cart. If the consumer accepts the incentive, he is redirected to a page where the order is completed. Some examples of incentives include a discount on the merchandise in the shopping cart; a discount on the shopping cart merchandise subject to the consumer making another purchase, either from the seller or from a third party; or a coupon for another item or service offered by a third party, in exchange for completing the original transaction. Incentives may be offered in some embodiments to customers who view an item and leave the site, even if the item was not actually placed in a shopping cart.

### BRIEF DESCRIPTION OF THE DRAWINGS

FIG. 1 is a block diagram illustrating components of a system for providing abandonment recovery in accordance with an embodiment of the present invention.

FIG. 2 illustrates an example of a user interface page displayed by a web server on a browser when a consumer is shopping online.

FIG. 3 illustrates an example of an offer page in accordance with an embodiment of the present invention.

FIG. 4 illustrates a method for providing abandoned shopping cart recovery in accordance with an embodiment of the present invention.

The figures depict preferred embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

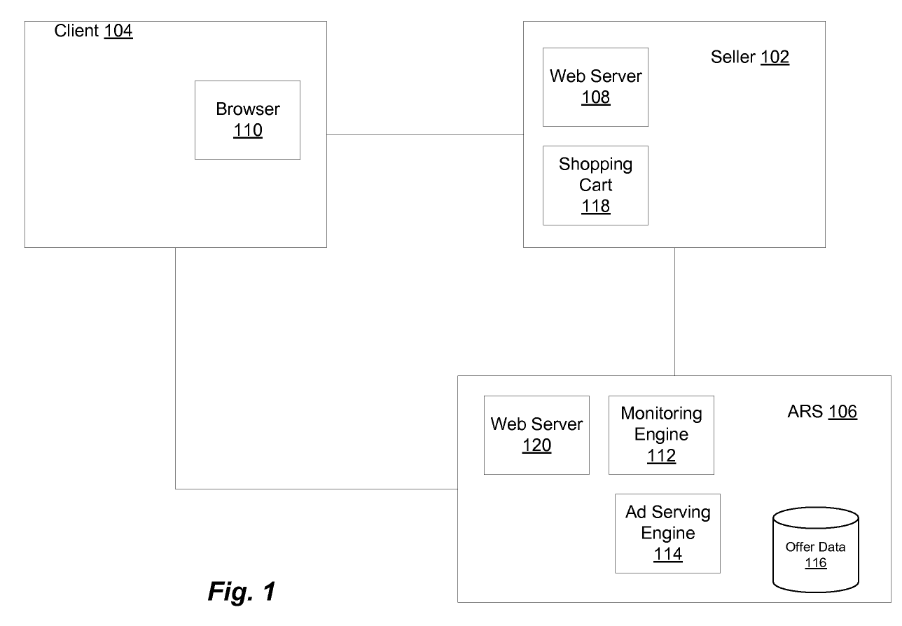

FIG. 1 illustrates an abandonment recovery service (ARS) 106 and its context in accordance with an embodiment of the present invention. ARS 106 includes a monitoring engine 112, an ad serving engine 114, and a offer database 116. ARS 106 is in communication with a seller 102, and can also be in communication with a client 104. Seller 102 operates a web server 108, and client 104 operates a browser 110. Although only one instance of a client and seller are illustrated, this is merely for convenience of description; ARS 106 scales to however many sellers and clients can be supported by the hardware and bandwidth of its implementation.

Seller 102 operates a web site on which it sells merchandise or services. A client 104 is a device used by a consumer to access web server 108 of seller 102. Client 104 may be a personal computer, PDA or any other network-enabled device able to access a web server such as web server 108. Browser 110 may be any conventional web browser such as Microsoft Internet Explorer, Mozilla Firefox, or the like. Web server 108 communicates with client 104 and provides client 104 with the ability to browse the goods and services available from seller 102. Web server 108 may be the Apache web server from the Apache Software Foundation, Internet Information Services from Microsoft, or another conventional web server. Seller 102 also includes a shopping cart module 118.

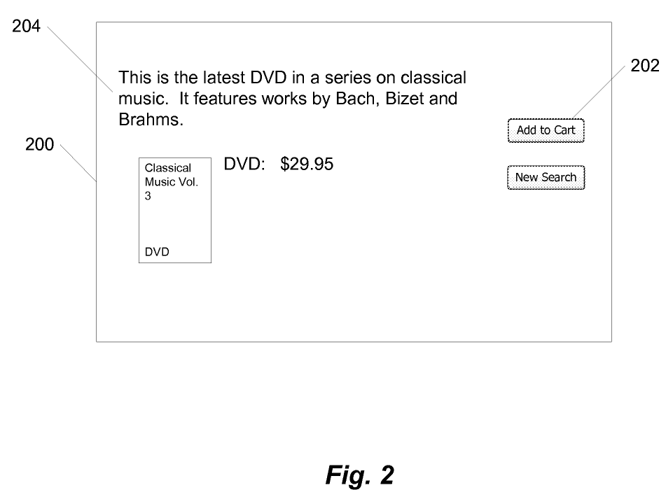

FIG. 2 illustrates an example of a user interface page 200 displayed by web server 108 on browser 110 when a consumer is shopping online. In the illustrated example, the consumer is viewing a page from which a DVD on classical music is described in region 204 and can be purchased. To purchase the DVD, the consumer clicks on the “add to cart” button 202. As will be appreciated by those of skill in the art, the particular arrangement of a user interface page 200 is not material to the described invention; it suffices that there is a mechanism by which the consumer can indicate an interest in purchasing the displayed item. Also note that while UI 200 displays merchandise for sale, i.e. a DVD, services may also be purchased via a shopping cart, such as, for example, airplane and hotel reservations, online quizzes, subscriptions and the like.

When the consumer selects the add to cart button 202, the selected item is placed in a shopping cart associated with the consumer by shopping cart module 118. Shopping cart module 118 then calls monitoring engine 112 of ARS 106. In one embodiment, data passed by shopping cart 118 to monitoring engine 112 in the call includes the seller's name or identification; session ID for the client 104 associated with the consumer; the product added to the shopping cart; an exit URL; the name of the window of browser 110 that should be monitored; a process ID of the monitoring page on the client 104; a shopping cart ID; a purchase amount; and the consumer's name and demographic information. More or less data may be passed by shopping cart 118 as required in a particular implementation.

In addition to making the call to monitoring engine 112, shopping cart 118 opens a monitoring window in browser 110 of client 104. In one embodiment, the window is opened in a minimized state.

Seller 102 configures pages on web server 108 in one embodiment to include JavaScript. When the consumer clicks on a link such as the add to cart button 202, the JavaScript causes the monitoring window to be opened on browser 110. In alternative embodiments, various combinations of Adobe Flash and Flex, Sun's Java, or other mechanisms may be used to cause the monitoring window to open, as will be understood by those of skill in the art.

In one embodiment, shopping cart module 118 also stores the same or similar data that was passed to monitoring engine 112 in a cookie on client 104. Monitoring engine 112 stores the received information, for example in offer database 116.

Each time the consumer adds a new item to the shopping cart, updated information is passed to monitoring engine 112, and in one embodiment the cookie on client 104 is also updated. In one embodiment, if the consumer closes the monitoring window, it is reopened upon the next triggering event such as when the consumer adds another item to the shopping cart.

In one embodiment, a web page on web server 108 updates a cookie on client 104 at a given interval, e.g., 500 milliseconds. We refer to the cookie as a heartbeat cookie. The cookie is given a time-to-live, e.g., of 1 second. The monitoring window checks for the presence of the cookie at some interval, e.g., 1 second. If the consumer navigates away from web server 108, the heartbeat cookie will expire without being replaced by a new cookie. In such a case, the monitoring window will expand as described below.

In some instances, such as when the consumer clicks on a link to another page on web server 108, the new page may not load during the time-to-live of the heartbeat cookie. To accommodate this, in one embodiment when the consumer clicks on a link to another page on web server 108 a new heartbeat cookie is stored with a greater time-to-live, e.g., 30 seconds or 1 minute.

If the consumer proceeds to purchase the items in the shopping cart via web server 108, then shopping card module 118 instructs browser 110 to close the monitoring window.

Alternatively, the consumer may abandon the shopping cart. For example, the consumer may navigate to a different web site or close the browser tab or window, or even remove items from the shopping cart—any of which leaves the purchase incomplete. Upon the abandonment of the cart, the monitoring page in browser 110 detects the absence of the heartbeat cookie and is maximized and redirected to an offer page on web server 120 of ARS 106.

Seller 102 in one embodiment determines a set of offers to give to consumers who have abandoned their shopping carts while using web server 108. In one embodiment, offers can be selected according to the identity of the consumer, the particular product or products abandoned, the value of the products abandoned, the time, date, or season, at random, or according to any other criteria that seller 102 can define. Seller 102 provides the offer criteria to ARS 106, where it is stored in offer database 116.

When a consumer's browser is redirected to web server 120 because the consumer has abandoned his shopping cart or navigated away from the seller's site, web server 120 reads the cookie stored in browser 110 to determine the identity of the consumer, the contents of the abandoned shopping cart, and other stored related information. Alternatively, or in an embodiment in which browser 110 does not have cookies enabled, the same or similar data is obtained from monitoring engine 112, that data having been passed by shopping cart module 118 as described above.

Ad serving engine 114 obtains the consumer information from web server 120 and performs a lookup into offer database 116 to determine an appropriate offer to make to the consumer based on the particulars of the transaction as described above. Once ad serving engine 114 has selected the appropriate offer, it is passed to web server 120 which then displays a web page containing the offer in the monitoring window of browser 110.

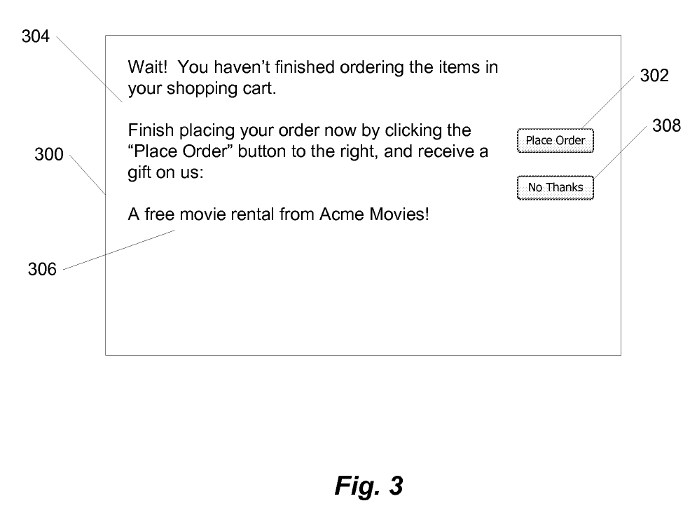

FIG. 3 illustrates an example of an offer page 300 in accordance with an embodiment of the present invention. In FIG. 3, the consumer is provided with a message 304 reminding him that he has not finished placing his order, and offering an incentive to complete it. The offer is described in region 306, and in the illustrated case is a free movie rental from Acme Movies. In an alternative embodiment, ad serving engine 114 presents a plurality of different offers and allows the consumer to select the offer of his choice in exchange for completing the transaction.

To complete the transaction the user selects the “Place Order” button 302, which in one embodiment causes the browser 110 to be redirected to web server 108 of seller 102 to complete the transaction. Ad serving engine 114 communicates to shopping cart module 118 the details of the accepted offer. Once the consumer successfully places the order, the incentive is made available to the user. In one embodiment, this is effected by linking the user to a coupon redemption page on web server 120 of ARS 106; alternatively, ad serving engine 114 provides the coupon particulars to seller 102 either once the transaction is completed or at the point the browser 110 is redirected to web server 108, and following completion of the transaction web server 108 provides the coupon to the consumer. In another embodiment, seller 102 communicates to ARS 106 that the transaction has been completed and ARS 106 e-mails the coupon to the consumer, or sends it via postal mail. The consumer is also able to decline the offer by clicking on button 308.

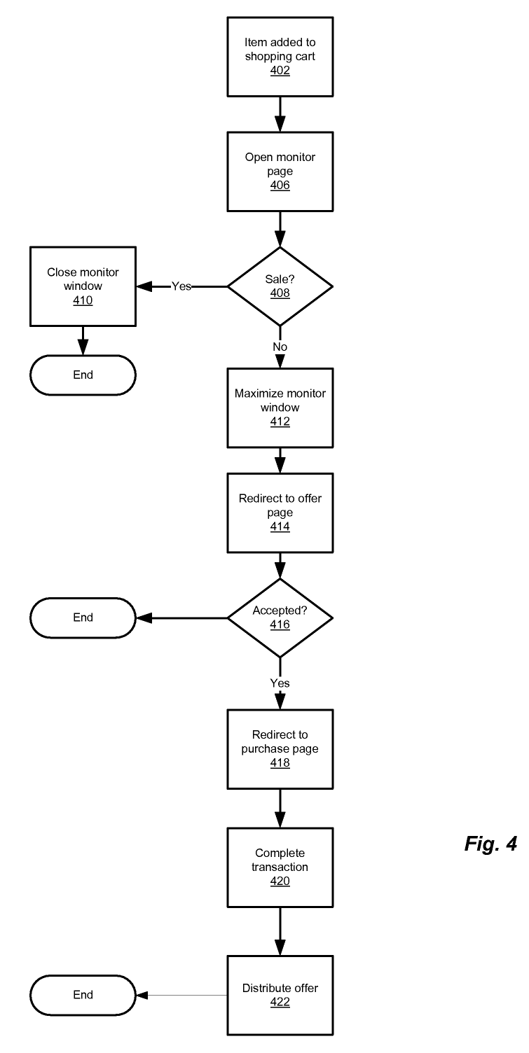

In view of the above, FIG. 4 illustrates a method for providing abandoned shopping cart recovery in accordance with an embodiment of the present invention. Initially at step 402 an item is added by the consumer to a shopping cart. Next, a monitoring page is opened 406 in the consumer's web browser. If 408 the consumer completes the transaction, the monitoring window is closed 410. If 408 the sale is not completed and the shopping card is abandoned, the monitoring window is maximized 412 and the consumer is redirected 414 to an offer page where he is provided with an incentive offer to complete the transaction. If 416 the consumer accepts the offer his browser is then redirected 418 to a purchasing page where the transaction is completed 420. Following the completion of the transaction, the accepted offer is distributed 422, e.g., through a coupon delivered to the consumer.

In one embodiment, the incentive provided to the consumer is a discount on the items abandoned in the shopping cart. Such a discount could also be offered subject to the consumer agreeing to make an additional purchase of a service or item not in his shopping cart. For example, the original total price of the shopping cart's contents might be $50, and an offer made to the consumer for a $20 discount on the contents of the cart in exchange for purchasing a $10 magazine subscription. The consumer therefore has an incentive to proceed, since the net savings is $10 plus a magazine subscription.

While we have described the ARS 106 and seller 102 as being separate entities, it is also possible for their functionality to be provided by a single entity such that seller 102 performs its own abandoned shopping cart recovery. In an embodiment where the seller 102 and ARS 106 are different entities, ARS 106 may charge seller 102 a fee, e.g., for each abandoned shopping cart that is converted into a completed transaction; a periodic fee; or a fee determined in some other manner agreed to by the parties involved.

Offers that are distributed to consumers by ad serving engine 114 in one embodiment are not for goods and services of seller 102, but are associated with third parties. For example, in the example provided above with respect to FIG. 2 and FIG. 3, seller 102 sells the classical music DVD, but is not the same entity as Acme Movies, the entity named in the offer. This allows agreements to be established independently between sellers and ARS 106; and between ARS 106 and offer providers. The association of certain offers with certain consumers or certain shopping cart items may be completely within the discretion of ARS 106, or alternatively sellers 102 and third parties may themselves have relationships with each other and specify to ARS 106 how offers should be implemented in some or all cases.

To ensure security and integrity of coupon offers, ad serving engine 114 in one embodiment associates an authorization code with each offer. When a consumer accepts an offer and is redirected to web server 108 of seller 102, the authorization code is also passed to seller 102. Upon completion of the transaction, seller 102 confirms the validity of the authorization code with ARS 106; upon confirmation that the offer is valid, the offer is issued.

In one embodiment, the transaction is completed by ARS 106 on behalf of seller 102, and the transaction details are then forwarded to seller 102 either in real time or in batches. In this embodiment, ARS 106 may also distribute coupons directly, or link consumers to the appropriate web side of a third-party coupon provider.

In one embodiment, consumers are provided with incentives to complete a transaction when they navigate away from the seller's 102 web site after they have viewed one or more items, even if no items have been added to the shopping cart. In this embodiment, the monitoring window is launched the first time a consumer views an item, rather than when the consumer adds an item to his shopping cart.

The present invention has been described in particular detail with respect to a limited number of embodiments. Those of skill in the art will appreciate that the invention may additionally be practiced in other embodiments. For example, although described above in the context of an online shopping cart, the present invention can also be used with respect to other online user experiences. In one embodiment, a user that is researching a product or performing product comparisons can be converted into a purchaser through extension of an offer.

Within this written description, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of the above description present the feature of the present invention in terms of algorithms and symbolic representations of operations on information. These algorithmic descriptions and representations are the means used by those skilled in the art to most effectively convey the substance of their work to others skilled in the art. These operations, while described functionally or logically, are understood to be implemented by computer programs. Furthermore, it has also proven convenient at times, to refer to these arrangements of operations as modules or code devices, without loss of generality.

It should be borne in mind, however, that all of these and similar terms are to be associated with the appropriate physical quantities and are merely convenient labels applied to these quantities. Unless specifically stated otherwise as apparent from the present discussion, it is appreciated that throughout the description, discussions utilizing terms such as “selecting” or “computing” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, the present invention is not described with reference to any particular programming language. It is appreciated that a variety of programming languages may be used to implement the teachings of the present invention as described herein, and any references to specific languages are provided for disclosure of enablement and best mode of the present invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

What is claimed is:

1. A method for preventing an abandoned transaction, the method comprising:
receiving a consumer selection of an item for purchase on a web page, the web page displayed in a first browser window;
adding the item to a shopping cart associated with the user;
detecting that the shopping cart has been abandoned; and
providing the consumer with an incentive to complete the purchase of the selected item.

2. The method of claim 1 wherein the incentive includes offering the item in the shopping cart to the consumer at a discounted price.

3. The method of claim 2 wherein the incentive includes requiring the consumer to purchase an additional item.

4. The method of claim 3 wherein the sum of the cost of the additional item and the discounted price of the item in the shopping cart is less than or equal to an original price of the item in the shopping cart.

5. The method of claim 1 wherein detecting that the shopping cart has been abandoned further comprises:
associating a cookie with the first browser window; and
responsive to an indication that the cookie has expired, determining that the shopping cart has been abandoned.

6. The method of claim 5 wherein providing the consumer with an incentive to complete the purchase of the selected item further comprises:
opening a second browser window;
responsive to the determination that the shopping cart has been abandoned, displaying the second browser window.

7. The method of claim 6 wherein contents of the second browser window describe the incentive.

8. A method for preventing an abandoned transaction, the method comprising:
receiving a consumer selection of an item for viewing on a web page, the web page displayed in a first browser window;
displaying the selected item on the web page;
detecting that the first browser window has been closed; and
providing the consumer with an incentive to complete a purchase of the selected item.

9. A system for preventing an abandoned transaction, the system comprising:
a monitoring engine, adapted to receive an indication that a shopping cart associated with a consumer has been abandoned;
a web server, coupled to the monitoring engine, adapted to display an incentive to the consumer via a web browser;
an offer database, adapted to store at least one incentive to be provided to consumers;
an advertisement serving engine, coupled to the offer database and to the web server, adapted to retrieve from the offer database an incentive to purchase items in the shopping cart, and to provide the incentive to the consumer via the web server.

10. The system of claim C1 wherein the monitoring engine is further adapted to notify a seller associated with the shopping cart that the consumer has accepted the incentive.
